(19) United States
(12) Patent Application Publication
(10) Pub. No.: US 2002/0051830 A1
(43) Pub. Date: May 2, 2002

(54) RESIN-VEHICLE-LAMP-MOLDING APPARATUS

(76) Inventors: OSAMI TAKIKAWA, SHIZUOKA (JP); MAKOTO SANO, SHIZUOKA (JP)

Correspondence Address: SUGHRUE MION ZINN MACPEAK & SEAS PLLC, 2100 PENNSYLVANIA AVENUE NW, WASHINGTON, DC, 200373202

(21) Appl. No.: 09/457,385

(22) Filed: Dec. 9, 1999

(30) Foreign Application Priority Data
Dec. 9, 1998 (JP) HEI. 10-350185

(51) Int. Cl. B29C 70/74

(52) U.S. Cl. 425/112; 425/126.1; 425/576

(57) ABSTRACT

To provide a moldingl die apparatus wherein simultaneous molding of two or more molded products of different sizes can be carried out. An apparatus for molding of resin products includes a pair of mutually confronting metal dies (30, 50) that are moveable toward and away from each other, molding surfaces or portion (32 (34), 52, (54)) that cooperate in forming mold cavities and resin path (70) that lead injected molten resin from an injection machine to the cavities provided in the metal dies. Two or more cavities C₁₆, C₂₆ of different capacities are provided in the metal dies (30, 50). Simultaneous molding of two or more different resin products (16, 26) with the single molding apparatus increases the production efficiency of the resin products and reduces the production costs. Further, the installation space for the molding equipment, such as the molding apparatus, can be reduced.

### BACKGROUND OF THE INVENTION

1. Field of the Invention

The present invention relates to an apparatus for molding front surface lenses of lamps for vehicles with a metal die, and specifically relates to a resin-product-molding apparatus which is appropriate for simultaneously molding resin products of different sizes.

2. Background

The front lenses which are utilized in rear combination lamps and backup-lamp-built-in tail lamps, that are marker lamps for automobiles, generally include a lower colorless (or clear) area 2 and an upper red area 3 which are molded as a single piece. Alternatively, the lenses may be formed from two-color molded lenses with one being red and the other colorless.

FIG. 7 shows a conventional apparatus for molding such lenses with a metal die. The apparatus comprises a fixed table 5 that includes lower molding metal dies A and B, and a vertically-movable rotary table 6 that includes upper molding metal dies C and D that correspond to the molding metal dies A and B. After the colorless areas 2 are molded with the molding metal dies A and C, the rotary table 6 is rotated 180 degrees with the molded products retained in the upper molding metal die C to mold the red areas 3 onto the colorless areas 2 with the molding metal dies B and C as an integrated single piece. Molten resin is injected from nozzles on an injection machine side into resin paths 7a and 8a inside the metal dies A and B through inlets 7 and 8.

It has been conventional to prepare an exclusive-use molding apparatus with metal dies for each of the lenses, where an exclusive-use molding apparatus with metal dies is used for molding of lenses for rear combination lamps while another exclusive-use molding apparatus with metal dies is used for molding lenses for backup-lamp-built-in tail lamps, if the lenses are used for lamps of different functions or if the sizes are different even though the functions of the lamps are the same. Therefore, even for the lamp lenses of the same production quantity, which are to be attached to the same types of vehicles, it has been necessary to prepare multiple molding metal dies for the lenses. Thus preparation of the molding metal dies is costly resulting an increase in the cost of the molded products.

Another problem is that one molding apparatus that can mold only lenses of one same type and size results in unfavorable production efficiency.

The present invention considers the above-described problems and the purpose thereof is to provide a resin-vehicle-lamp-molding apparatus with metal dies wherein two or more different sizes of molded products can be molded simultaneously.

### SUMMARY OF THE INVENTION

The above-described purpose cain be achieved by a resin-vehicle-lamp-molding apparatus which comprises a pair of mutually confronting main body molding metal dies that can move toward and away from each other, molding surfaces that are disposed on the mutually confronting main body molding metal dies so as to cooperate in forming of mold cavities and resin paths that lead injected molten resin from an injection machine to the cavities wherein two or more cavities of diverse capacities are provided in the main body molding metal dies. Filling of resin in the cavities provided in the molding metal dies enables simultaneous molding of two or more different resin products.

The resin-vehicle-lamp-molding apparatus is designed such that the amount of resin injected into the cavities per unit time is adjusted so that the cavities are filled with resin in approximately the same duration of time. If the duration of time for filling the resin into the respective cavities is different, the duration of time for injecting resin from the injection machine needs to be varied from one cavity to the other. However, since the duration of time for filling the resin respectively into the respective cavities is approximately the same, control of the time duration is simplified.

According to the invention, the adjustment of amount of resin injection into the cavities per unit time is accomplished by forming the resin paths that lead to the cavities so that the cross-sectional areas thereof will be appropriate to the respective capacities of the cavities. For cavities of large capacities, the amount of resin injected into the cavities per unit time is increased by enlarging the cross-sectional area of the resin paths whereas, for the cavities of small capacities, the amount of resin injected into the cavities per unit time is decreased by reducing the cross-sectional areas of the resin paths. Thus the duration of time for filling the cavities with resin is approximately the same for each of the cavities.

A concrete adjustment method of the cross-sectional areas of the resin path is to adjust the cross-sectional areas of the resin paths themselves that lead to the cavities and/or the opening areas of the gates that open to the cavities, and appropriate adjustment of them enables smooth operation of resin filling into the cavities.

According to one embodiment, the resin paths include branch paths that branch from the main paths and lead to the respective cavities, with a hot runner disposed within each branch path. If a particular hot runner does not operate, the resin inside the branch path will remain solidified and not flow. Thus, actuation of selected hot runners that are appropriated to the cavities for use in specific molding alone enables selective use of specific cavities.

Hence, simultaneous molding of diverse kinds of resin products is enabled by varying of the color and type of the resin supplied to the resin paths.

According to the invention, the main body molding metal dies includes a fixed molding metal die in which the resin paths are provided and a movable molding metal die that is moveable toward and away from the fixed molding metal die. The fixed molding metal die comprises at least two units, a first fixed molding metal die and a second fixed molding metal die, in such manner that a primary molded product that was molded with the first fixed mold and movable mold is inserted into a molding cavity that is formed by the secondary fixed molding metal die and movable molding metal die for secondary molding.

### BRIEF DESCRIPTION OF DRAWINGS

The invention will be described with reference to the drawings in which:

FIG. 1 is a perspective view of the rear part of an automobile;

FIG. 2 is a perspective view of a molding apparatus with metal dies as an embodiment of the present invention;

FIG. 3 is a longitudinal section of the same molding apparatus;

FIG. 4 is a top view of the lower molding metal die of the same molding metal die apparatus;

FIG. 5 is a perspective view of an alternative embodiment of the present inventions;

FIG. 6 is a front view of the front surface lens utilized for conventional marker lamps; and

FIG. 7 is a perspective views of a conventional molding metal die apparatus

### DETAILED DESCRIPTION OF THE INVENTION

Embodiments of the present invention are described hereinafter with references to the above described drawings.

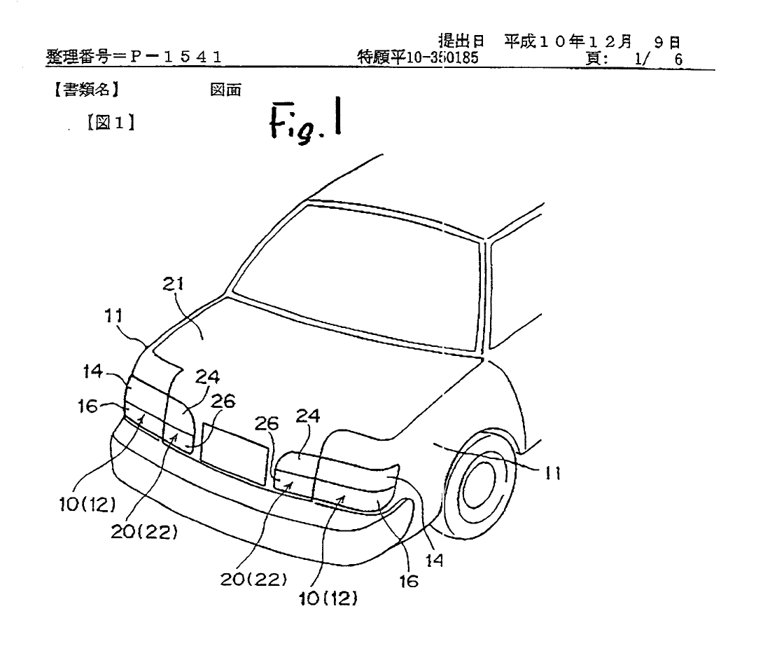

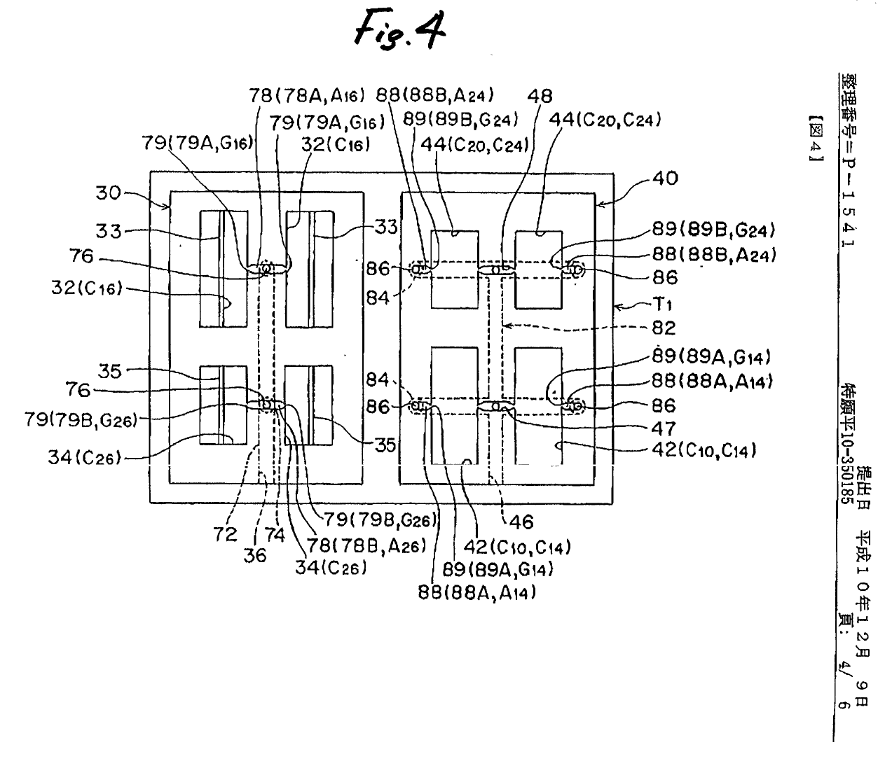

A resin-vehicle-lamp-molding apparatus with metal dies as an embodiment of the present invention is shown in FIGS. 1 through 4. FIG. 1 shows right and left rear combination lamps 10 that are provided on a rear fender 11 and right and left backup-lamp-built-in tail lamps 20 that are provided on a trunk lid 20. The lamps 10 and 20 are disposed so as to adjoin each other.

The rear combination lamp 10 is structured such that a tail-and-stop lamp and a turn signal lamp are integrated as a single unit. On a front surface lens 12 associated with the lamp there is provided as an integrated unit, a red area 14 that functions as an illuminating part of the tail-and-stop lamp and a colorless or clear area 16 that functions as an illuminating part of the turn signal lamp

Locked next to the rear combination lamp, the backup-lamp-built-in tail lamp 20 has a structure which includes a tail lamp and a backup lamp which are integrated into a single unit. On a front surface lens 22 associated with the tail lamp 20, there is provided as an integrated unit, a red area 24 that functions as an illuminating part of the tail lamp and a colorless area 26 that functions as an illuminating part of the backup lamp.

The front surface lenses 12 and 22 of both the lamps 10 and 20 are formed such that the front surface lenses 12 are wider than the front surface lenses 22 whereas the heights thereof are approximately the same. In addition, the red areas 14 and 24 and the colorless areas 16 and 26 are of approximately the same height so as to provide a visual appearance of an integrated single body which includes the lamps 10 and 20.

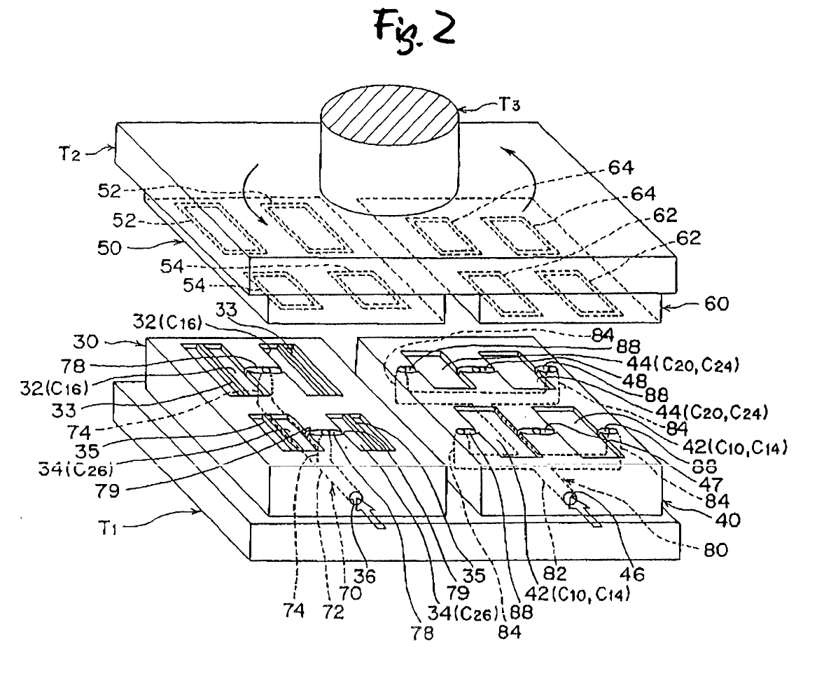

The molding apparatus with metal dies shown in FIG. 2 includes a fixed table T1 in which lower molding metal dies 30 and 40 of a rectangular block shape are disposed in parallel and a rotary table T2 which is moveable toward and away from the fixed table and in which molding metal dies 50 and 60 of a rectangular block shape are disposed in parallel so as to confront the lower metal dies 30 and 40. T3 is a rotary shaft of the rotary table T2.

Mold surfaces 42 for molding the full front surface side of the front surface lenses 12 of the rear combination lamps 10 and mold surfaces 44 for molding the full front surface side of the front surface lenses 22 of the backup-lamp-built-in tail lamps 20 are formed on the lower metal pattern 40. Mold surfaces 52 (62) for molding the full back surface side of the front surface lenses 12 of the rear combination lamps 10 and mold surfaces 54 (64) for molding the full back surface side of the front surface lenses 22 of the backup-lamp-built-in tail lamps 20 are formed on the upper metal die 50 (60) respectively.

The mold surfaces 42 on the lower molding metal die 40 and the mold surfaces 52 (62) on the upper molding metal die 50 (60) and the mold surfaces 44 on the lower molding metal die 40 and the mold surfaces 54 (64) on the upper molding metal die 50 (60) respectively cooperate to form cavities C₁₀ (C₂₀) for molding of the full front surface lenses 12 and 22. When the primary molded products of the colorless areas 16 and 26 of the lenses which were formed with the lower molding metal die 30 and the upper molding metal die 50 (60) are inserted into the cavities C₁₀ (C₂₀), cavities C₁₄ (C₁₄) which match the red areas 14 and 24 of the lenses are formed. That is, the lower molding metal die 40 and the upper molding metal die 60 constitute molding metal dies for secondary molding of the red areas 14 and 24 of the lenses onto the colorless areas 16 and 26 of the lenses, which are the primary molded product, as the integrated single pieces.

Depressed parts of the same size as the mold surfaces 42 and 44 in the lower molding metal die 40 are formed on the lower molding metal die 30 so as to match, and mold surfaces 32 and 34 which are partitioned by protruding ribs 33 and 35 are provided inside the depressed parts. The mold surfaces 32 mold the front surface side of the colorless arenas 16 of the front surface lenses 12 for the rear combination lamps 10, and the mold surfaces 34 mold the front surface side of the colorless areas 26 of the front surface lenses 22 for the backup-lamp-built-in tail lamps 20 The mold surfaces 32 on the lower molding metal die 30 and the mold surfaces 52 (62) on the upper molding metal die 50 (60) and the mold surfaces 34 on the lower molding metal die 30 and the mold surfaces 54 (64) on the upper molding metal die 50 (60) respectively cooperate to form cavities C₁₆ and C₂₆ that match the colorless areas 16 and 26 of the lenses. That is, the lower molding metal die 30 and the upper molding metal dies 50 and 60 constitute molding metal dies for primary molding of the colorless areas 16 and 26 of the lenses which are the primary molded products.

A resin path 70 (which runs through the inside of the molding metal die 30 from a resin supply inlet 36, that opens on the lateral side and then exposes itself on the upper surface of the molding metal die 30 so as to communicate with the cavities C₁₆ and C₂₆) is disposed on the lower molding metal die 30. The resin path 70 includes (1) a manifold 72 that runs horizontally inside the molding metal die 30, (2) two hot runners 74 that constitute branch paths extending from the manifold 72, which run vertically upward at approximately the center of the molding metal die and communicate with the upper surface of the molding metal die 30 via sprues 76, and (3) runners 78 that run from the sprues 76 along the upper surface of the molding metal die and communicate with the cavities C₁₆ and C₂₆ via gates 79.

Similarly, a resin path 80 (which runs through the inside of the molding metal die 40 from a resin supply inlet 46 which opens on the lateral side and then exposes itself on the upper surface of the molding metal die 40 so as to communicate with the cavities C₁₄ and C₂₄) is disposed on the lower molding metal die 40. The resin path 80 includes (1) a manifold 82 that runs lengthwise and crosswise horizontally inside the molding metal die 40, (2) four hot runners 84 that constitute branch paths extending from the manifold 82, which run vertically upward at positions close to the crosswise ends of the molding metal die and expose themselves on the upper surface of the molding metal die 40 via sprues 86, and (3) runners 88 that run from the sprues 86 over the upper surface of the molding metal die and communicate with the cavities C₁₄ and C₂₄ via gates 89.

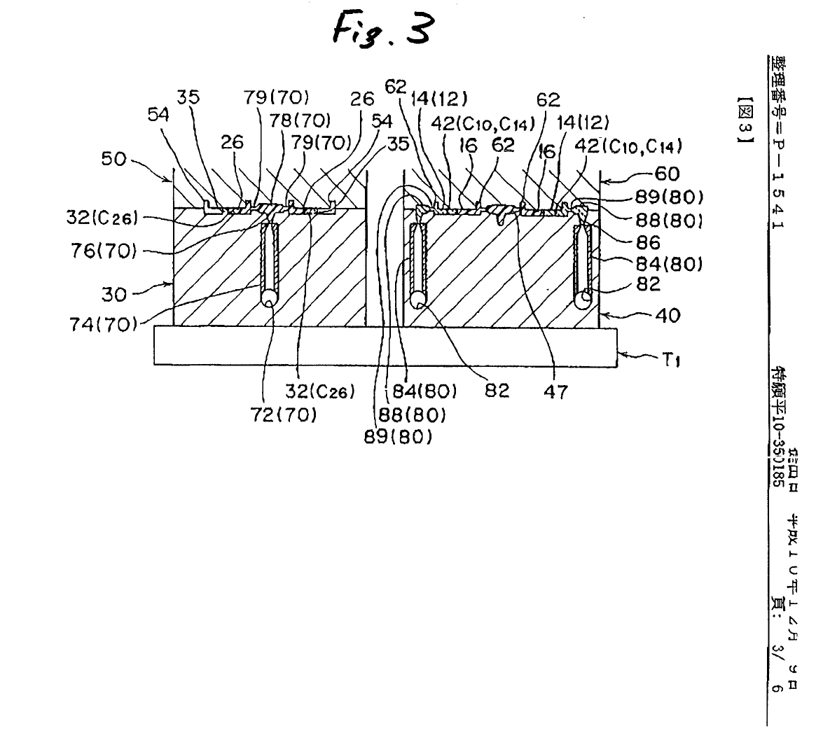

As shown in FIGS. 2 and 3, grooves 47 and 48 for storing the sprues that are formed in the upper surface of the molding metal die 40 are disposed at the positions where the sprues 76, which are integrated into single pieces with the colorless areas 16 (26) of the primary molded lenses, can be stored.

With references to the molding apparatus with metal dies shown in FIGS. 2 through 4, molding procedures for molding the front surface lenses 12 and 22, respectively, of the rear-combination-lamps 10 and the backup-lamp-built-in tail lamps 20 are described now.

Firstly, the rotary table T2 descends from the state shown in FIG. 2 to engage the upper and lower molding metal dies, and the molding metal dies 30 and 50 mold the colorless areas 16 and 26 of the lenses. That is, from a nozzle of an injection machine (not shown), molten resin is supplied to the resin supply inlet 36 as shown by the arrow in FIG. 2. The molten resin, flowing along the resin path 70, fills the cavities C₁₆ and C₂₆ through the gates 79 and solidifies.

Next, the rotary table T2 ascends to separate the upper and lower molding metal dies while the molded colorless areas 16 and 26 of the lenses are retained on the mold surfaces 52 and 54 of the upper metal mold 50 by being tightly adhering thereto. Then, as shown by the arrow in FIG. 2, the rotary table T2 rotates 180 degrees and the upper metal mold 50 is positioned against the lower metal mold 40 while the upper metal mold 60 is positioned against the lower mold 30.

Next, the rotary table T2 descends to engage the upper and lower molding metal dies, and the molding metal dies 50 and 40 mold the red areas 14 and 24 of the lenses. That is, when the upper molding metal die 50 engages the lower molding metal die 40, the colorless areas 16 and 26 of the lenses are stored and retained inside the cavities C₁₀ and C₂₀. Then, from a nozzle of an injection machine (not shown), molten resin is supplied to the resin supply inlet 46 as shown by another arrow in FIG. 2. The molten resin flows along the resin path 80, filling the cavities C₁₄ and C₂₄ through the gates 89. The red areas 14 and 24 of the lenses are thus molded onto the colorless areas 16 and 26 of the lenses, which have been retained in the cavities C₁₀ and C₂₀, as an integrated single pieces.

When the rotary table T2 ascends to open the molds, the front surface lenses 12 and 22, as the secondary molded products, are discharged from the molding metal dies. Then, the rotary table T2 rotates 180 degrees to return to the state shown in FIGS. 2, and the above-described actions are repeated.

Since the upper molding metal dies are formed in exactly the same shape, while the red areas 14 and 24 of the lenses are molded onto the colorless area 16 and 26 of the lenses using the molding metal dies 50 and 40 as integrated single pieces (secondary mold), the colorless areas 16 and 26 of the lenses are primarily molded using the molding metal dies 60 and 30. Similarly, while the colorless areas 16 and 26 of the lenses are molded using the molding metal dies 50 and 30, the red areas 14 and 24 of the lenses are molded onto the colorless areas 16 and 26 of the lenses using the molding metal dies 60 and 40 as integrated single pieces (secondary mold). Thus, the primary mold and the secondary mold are carried out simultaneously.

The front surface lens 12 is larger than the front surface lens 22, and the red area 14 and the colorless area 16 of the lens 12 are larger than the red area 24 and colorless area 26 of the lens 22, respectively. Therefore, the capacities of the cavities C₁₄ (C₁₆) are larger than the capacities of the cavities C₂₄ (C₂₆). Accordingly, it all of the cross-sectional areas of the resin paths 70 and 80 and the opening areas of the gates 79 and 89 per cavity are exactly the same, resin filling into the cavities C₁₆ (C₁₄) of large capacities has not finished by the time of completion of resin filling into the cavities C₂₆ (C₂₄) of small capacities. Thus, the control becomes highly complicated since the resin injected from the injection machines needs to be controlled for each city.

In this embodiment, however, the duration of time for filling the resin into each of the cavities C₁₆ and C₂₆ is adjusted to be approximately the same by controlling the cross-sectional areas A₁₆ and A₂₆ of the runners 78A and 78B that lead-to the cavities C₁₆ and C₂₆ and the opening areas G₁₆ and G₂₆ of the gates 79A and 79B that face the cavities C₁₆ and C₂₆ such that A₁₆>A₂₆ and G₁₆>A₂₆.

Additionally, the duration of time for filling the resin into each of the cavities C₁₄ and C₂₄ is adjusted to be approximately the same and also to be equal to the duration of time for filling the resin into each of the cavities C₁₆ and C₂₆ by controlling the cross-sectional areas A₁₄ and A₂₄ of the runners 88A and 88B that lead to the cavities C₁₄ and C₂₄ and the opening areas G₁₄ and G₂₄ of the gates 89A and 89B that face the cavities C₁₄ and C₂₄ such that A₁₄>A₂₄ and G₁₄>A₂₄. This enables simultaneous filling of resin from the injection machines to the resin inlets 36 and 46. Therefore, molding process control, including the injection machine control, is simplified that much.

The resin temperatures inside the hot runners 74 and 84 that run through the molding metal dies 30 and 40 are controllable by adjusting the heating values of the heaters provided inside the hot runners 74 and 84. In addition, the resins inside the hot runners 74 and 84 are retainable in a non-flowing state by shutting off the power to prescribed hot runner heaters. Thus, a selective use of a plurality of hot runners 74 and 84 that are provided on the molding metal dies 30 and 40, respectively, enables the molding of either the front surface lenses 12 for the rear combination lamps 10 or the front surface lenses 22 for the backup-lamp-built-in tail lamps 20.

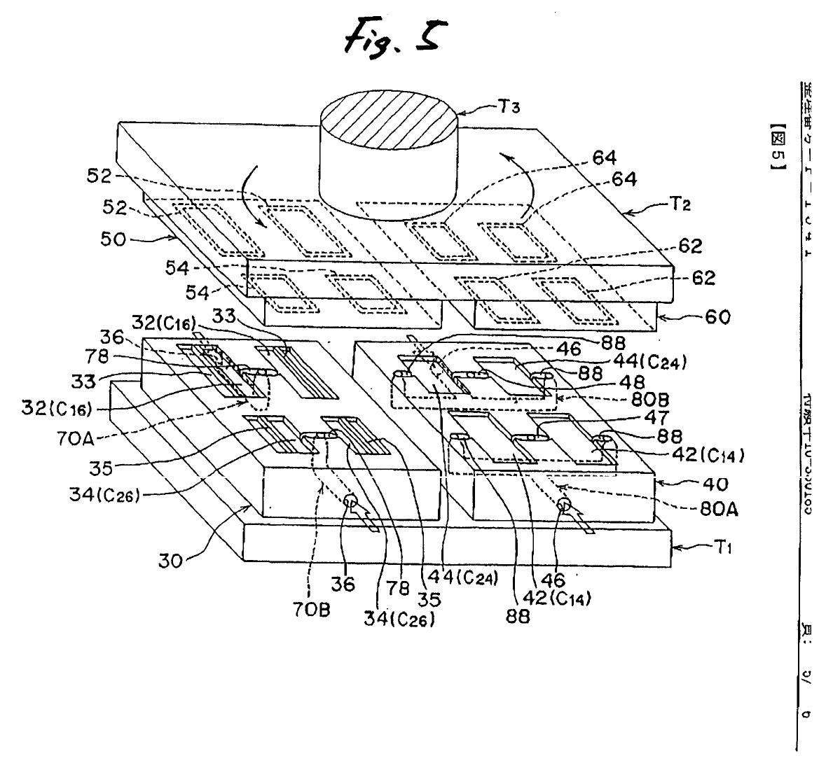

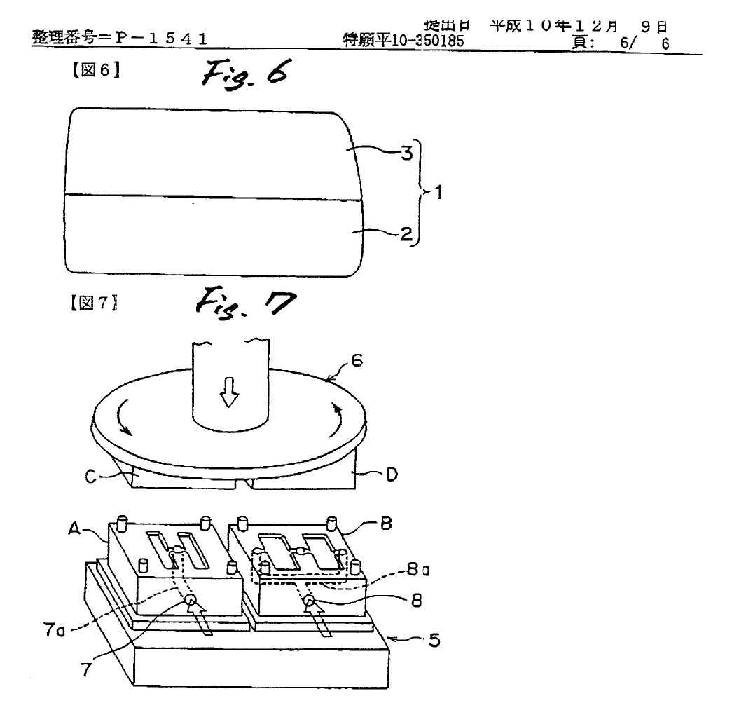

FIG. 5 shows an alternative embodiment of the present invention and is a perspective view of the molding apparatus with metal dies for molding of the marker lamps or the rear combination lamps and backup-lamp-built-in tail lamps

In the previous embodiment, the molding metal die 30 (40) is provided with the single resin inlet 36 (46) and the resin is supplied to the cavities C₁₆ and C₂₆ (G₁₄ and G₂₄) of different capacities through the single resin path 70 (80). On the other hand, in this embodiment, the molding metal dies 30 and 40 are provided with two resin inlets 36 and 46 respectively and each of the cavities C₁₆ and C₂₆ (G₁₄ and G₂₄) of different capacities is provided with an independent resin path 70A or 70B (80A or 80B). Thus, if compared with the above-described molding apparatus, each of the cavities C₁₄ and C₂₆ (G₁₄ and G₂₄) can be filled with resin in a shorter duration of time. Moreover, supply of resins of different colors to the resin paths 70A and 70B (80A and 80B) enables molding of front surface lenses of colors different from one another.

The other parts thereof are the same as the first embodiment and thus the same symbols are given to eliminate the descriptions thereon.

As is clear from the descriptions above, the invention enables simultaneous molding of two or more different resin products with a single molding apparatus and thus the production efficiency of the resin products is improved while the production costs are reduced, which accordingly enables production of automotive parts for lower prices. Additionally, the quantity of equipment, such as the molding apparatuses, can be reduced and thus the installation space for the molding equipment can be reduced. Also, the invention simplifies the injection time control and thus the control system structure can also be simplified. Further, smooth operation of resin filling into each of the cavities is ensured and, since the duration of time for filling the resin into each of the cavities is controlled approximately to be the same, appropriate molding cycles can be carried out. Further the selective use of desired cavities enables molding of selected items of resin products alone. Also, the invention enables simultaneous molding of plural kinds of resin products having different colors and/or materials, which is highly effective.

What is claimed is:

1. A resin-vehicle-lamp-molding apparatus, comprising;
a pair of mutually confronting main body molding metal dies that are moveable toward and away from each other; and
molding portions disposed on each of said main body molding metal dies so as to cooperate in forming at least two mold cavities, where one of said main body molding metal dies has resin paths that lead injected molten resin from an injection machine to said cavities, and wherein said mold cavities have different capacities.

2. The resin-vehicle-lamp-molding apparatus claimed in claim 1, wherein the amount of resin injected into said cavities per unit time is adjusted so that said cavities are filled respectively with resin in approximately the same time.

3. The resin-vehicle-lamp-molding apparatus claimed in claim 2, wherein said adjustment of amounts of resin injected into said cavities per unit time is carried out by forming said resin paths that lead to the cavities so that the cross-sectional areas thereof will be appropriate to the respective capacities of the cavities.

4. The resin-vehicle-lamp-molding apparatus claimed in claim 1, wherein said resin paths comprise branch paths that respectively lead to the cavities and wherein each of said branch paths includes a hot runner.

5. The resin-vehicle-lamp-molding apparatus claimed in claim 1, wherein said resin paths independently communicate with said cavities, respectively, and said resin paths are provided with hot runners respectively.

6. The resin-vehicle-lamp-molding apparatus claimed in claim 1, wherein said main body molding metal dies include a fixed molding metal die that is provided with said resin paths and a movable molding metal die that is moveable toward and away from said fixed metal die, and wherein said fixed molding metal die includes at least two units corresponding to a first fixed molding metal die and a second fixed molding metal die, in such manner that a primary molded product that was molded with said first fixed molding metal die and movable mold is inserted into a molding cavity that is formed by said second fixed molding metal die and movable metal die for secondary molding.

7. A molding apparatus comprising:
a pair of mutually confronting main molds that are moveable toward and away from each other, each said main molds having at least two mold cavities and resin paths that lead injected molten resin from an injection machine to said cavities, said mold cavities having different capacities.

8. The molding apparatus claimed in claim 7, wherein the rate at which resin is injected into a first of said cavities is different from the rate at which resin is injected into a second one of said cavities so that said cavities are respectively filled with resin in approximately the same time.

9. The molding apparatus claimed in claim 8, said rate at which resin is injected into said first and second cavities is differentiated by forming said resin paths that lead to the cavities so that the cross-sectional areas thereof will be appropriate to the respective capacities of the cavities.

10. The molding apparatus claimed in claim 7, wherein said resin paths comprise branch paths that branch off of said resin paths and lead to the cavities, respectively each of said branch paths being provided with a hot runner.

11. The molding apparatus claimed claim 7, wherein said resin paths respectively communicate with said cavities independently, said resin paths being provided with hot runners respectively.
